(19) United States
(12) Patent Application Publication
(10) Pub. No.: US 2013/0021588 A1
(43) Pub. Date: Jan. 24, 2013

(54) MEASUREMENT APPARATUS, EXPOSURE APPARATUS, AND METHOD OF MANUFACTURING DEVICE

(71) Applicants: Takahiro MATSUMOTO, Utsunomiya-shi (JP); Wataru YAMAGUCHI, Utsunomiya-shi (JP)

(72) Inventors: Takahiro MATSUMOTO, Utsunomiya-shi (JP); Wataru YAMAGUCHI, Utsunomiya-shi (JP)

(73) Assignee: CANON KABUSHIKI KAISHA, Tokyo (JP)

(21) Appl. No.: 13/552,835

(22) Filed: Jul. 19, 2012

(30) Foreign Application Priority Data
Jul. 21, 2011 (JP) 2011-160300

(51) Int. Cl. G01B 11/14; G03B 13/28

(52) U.S. Cl. 355/45; 356/498

(57) ABSTRACT

A measurement apparatus includes a beam splitter that splits light from a light source into measurement light to be directed to an object to be measured and reference light to be directed to a reference surface, a beam combiner that combines the measurement light reflected by the object and the reference light reflected by the reference surface to generate combined light, and obtains physical information of the object based on the combined light. The measurement apparatus further includes a coherence controller which changes spatial coherences of the measurement light and the reference light.

### BACKGROUND OF THE INVENTION

1. Field of the Invention

The present invention relates to a measurement apparatus, an exposure apparatus, and a method of manufacturing a device.

2. Description of the Related Art

An exposure apparatus is employed to manufacture a semiconductor device such as a semiconductor memory or a logic circuit, or a display device such as a liquid crystal display device using photolithography. The exposure apparatus projects a circuit pattern formed on an original onto a substrate via a projection optical system to expose the substrate to light. The circuit pattern is transferred onto the substrate by exposure. The minimum feature size (resolution) that the exposure apparatus can transfer is proportional to the wavelength of light used for exposure, and is inversely proportional to the numerical aperture (NA) of the projection optical system. This means that shortening the wavelength of light used for exposure improves the resolution. Hence, the recent light sources have shifted from ultra-high pressure mercury lamps (the g-line (wavelength: about 436 nm) and the i-line (wavelength: about 365 nm)) to a KrF excimer laser (wavelength: about 248 nm) and an ArF excimer laser (wavelength: about 193 nm), and immersion exposure has been put into practice as well. Further, an EUV exposure apparatus which uses EUV light having a wavelength around 13.4 nm is under development.

A step-and-repeat exposure apparatus (also called a “stepper”) and a step-and-scan exposure apparatus (also called a “scanner”) are available as exposure types. In a scanner, before the exposure position on a substrate reaches an exposure slit region, its surface position (level) at this exposure position is measured by an oblique-incidence surface detection device, and adjusted to an optimum imaging position in exposure at this exposure position. A plurality of measurement points are arranged in the longitudinal direction of the exposure slit region (that is, a direction perpendicular to the scanning direction) to measure not only the surface position (level) of the substrate but also its surface tilt. Japanese Patent Laid-Open No. 6-260391 describes a method of measuring the surface position and tilt of the substrate using an optical sensor.

FIG. 16 illustrates how to use the optical sensor. Measurement light MM strikes the surface of a substrate SB having a variation in reflectance. A longitudinal direction β′ of the irradiation region of the measurement light MM is tilted by an angle A with respect to the boundary line between regions with different reflectances. The scanning direction of the substrate SB during measurement is indicated by an arrow α′ pointing in a direction perpendicular to the direction β′. FIG. 17 shows the intensity distributions of light beams, reflected by the substrate SB, along lines A-A′, B-B′, and C-C′. The intensity distributions of the reflected light beams along the lines A-A′ and C-C′ on which the reflectance is uniform have good symmetry, while that along the line B-B′ which traverses the regions with different reflectances has asymmetry and therefore generates a measurement error due to a shift in barycenter. This causes asymmetry in a detected waveform obtained by detecting that reflected light beam or considerably lowers the contract of the detected waveform, thus making it difficult to accurately measure the surface position the substrate. As a result, large defocus occurs, so chip defects may be produced. Under the circumstances, a demand has arisen for a technique which is insusceptible to the reflectance distribution on the surface of an object to be measured and serves to accurately obtain its surface information such as its surface position and surface shape.

### SUMMARY OF THE INVENTION

The present invention provides a technique advantageous in accurately obtaining the physical information of an object to be measured.

One of the feature of the present invention provides a measurement apparatus which includes a beam splitter that splits light from a light source into measurement light to be directed to an object to be measured and reference light to be directed to a reference surface, and a beam combiner that combines the measurement light reflected by the object and the reference light reflected by the reference surface to generate combined light, and obtains physical information of the object based on the combined light, the apparatus comprising a coherence controller which changes spatial coherences of the measurement light and the reference light.

Further features of the present invention will become apparent from the following description of exemplary embodiments with reference to the attached drawings.

### BRIEF DESCRIPTION OF THE DRAWINGS

FIG. 1 is a view showing the schematic configuration of a measurement apparatus according to the first embodiment of the present invention;

FIGS. 2A to 2F are graphs schematically showing a signal processing method;

FIGS. 3A to 3C are views for explaining the principle of spatial coherence control;

FIG. 4 is a flowchart showing a measuring sequence in a first example;

FIG. 5 is a flowchart showing a measuring sequence in a second example;

FIG. 6 is a graph illustrating the measurement result obtained in a low-coherence mode;

FIG. 7 is a graph illustrating the measurement result obtained in a high-coherence mode;

FIGS. 8A and 8B are views showing the schematic configuration of a measurement apparatus according to the second embodiment of the present invention;

FIG. 9 is a view showing the schematic configuration of a measurement apparatus according to the third embodiment of the present invention;

FIGS. 10A to 10C are views for explaining the fourth embodiment of the present invention;

FIGS. 11A and 11B are views illustrating illumination systems;

FIG. 12 is a view showing the schematic configuration of an exposure apparatus according to the fifth embodiment of the present invention;

FIG. 13 is a flowchart showing an exposing method according to the fifth embodiment of the present invention;

FIG. 14 is a view showing the schematic configuration of an exposure apparatus according to the sixth embodiment of the present invention;

FIG. 15 is a flowchart showing an exposing method according to the sixth embodiment of the present invention;

FIG. 16 is a view illustrating a measurement region; and

FIG. 17 is a graph for explaining the problem of the conventional measurement apparatus.

### DESCRIPTION OF THE EMBODIMENTS

Some embodiments of the present invention will be described below with reference to the accompanying drawings. Note that the same reference numerals denote the same elements throughout the accompanying drawings.

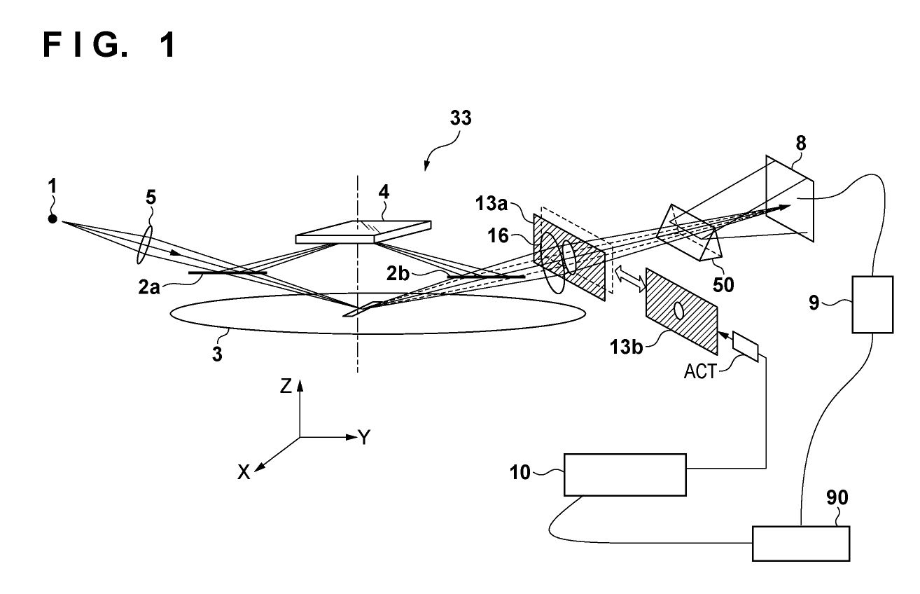

FIG. 1 is a view showing the schematic configuration of a measurement apparatus 33 according to the first embodiment of the present invention. The measurement apparatus 33 is configured to detect the surface position of a substrate (for example, a wafer) 3 as an object to be measured, that is, the position of the surface of the substrate 3 in the height direction (Z-direction) as the physical information of the substrate 3 while scanning the substrate 3 in one direction (Y-direction), thereby measuring the surface shape of the substrate 3. Note that the measurement apparatus 33 also serves as a measurement apparatus which measures the surface position (level) of the object to be measured as the physical information of the substrate 3. The measurement apparatus 33 includes a light source 1, beam splitter 2a, reference surface 4, beam combiner 2b, imaging optical systems 5 and 16, aperture stops 13a and 13b, spectrometer 50, image sensor 8, calculating unit 9, coherence controller 10, and main controller 90. The light source 1 can include an LED (including a so-called white LED) or halogen lamp which emits broadband light as light for measurement. The broadband light means light having a spectral band that can be spectroscopically analyzed by the spectrometer 50. The calculating unit 9 processes a signal detected by the image sensor 8. The coherence controller 10 controls the position of the aperture stop 13b. The main controller 90 controls the calculating unit 9 and coherence controller 10. Note that the calculating unit 9, the coherence controller 10, and the main controller 90 each may at least partly be implemented by one processor.

Light emitted by the light source 1 passes through the imaging optical system 5, and is split by the beam splitter 2a into two nearly half light beams, which strike the substrate 3 and the reference surface 4, respectively, by oblique incidence. If, for example, the shape of the resist surface on the substrate 3 coated with a translucent film such as a resist is to be measured, an incident angle θin is preferably equal to or larger than the Brewster angle of the resist in order to increase the reflectance of this resist surface. The incident angle θin can fall within the range of, for example, 70° to 85°. Although the wavelength band of light emitted by the light source 1 can be, for example, 400 nm to 800 nm, it is preferably 100 nm or more. However, if a resist is coated on the substrate 3, it is desired not to irradiate the substrate 3 with light having wavelengths equal to or shorter than those of ultraviolet rays (350 nm) so as to prevent the resist from being exposed to light.

The beam splitter 2a can be, for example, a cube beam splitter formed using a film such as a metal film or a multilayer of dielectric material as a split film, or a pellicle beam splitter formed by a film (its material is, for example, SiC or SiN) having a thickness of about 1 μm to 10 μm. The beam combiner 2b can have the same configuration as that of the beam splitter 2a. Of measurement light and reference light split by the beam splitter 2a, the measurement light is directed to the substrate 3 and reflected by the substrate 3 and enters the beam combiner 2b. On the other hand, the reference light is directed to the reference surface 4 and reflected by the reference surface 4 and enters the beam combiner 2b. The beam combiner 2b combines the measurement light and reference light to generate combined light. A glass plane mirror having a surface accuracy of about 5 nm to 20 nm, for example, is preferably used as the reference surface 4. The measurement light and reference light are combined into combined light (interfering light) by the beam combiner 2b, and the combined light strikes the image sensing surface of the image sensor 8 via the spectrometer 50.

The spectrometer 50 can be implemented by, for example, a dispersing prism. The combined light (interfering light) obtained by the measurement light and reference light is dispersed in the wavelength direction by the dispersing prism to form on the image sensing plane of the image sensor 8 an image which extends in the spatial resolution direction (X-direction) and in the wavelength resolution direction. The image sensor 8 detects this image as a signal of spectrometric interfering light including one-dimensional position information (X-direction) and wavelength information (spectrometric signal). The imaging optical system 5 forms an image of the light source 1 on the substrate 3. The imaging optical system 16 forms on the image sensing surface of the image sensor 8 again the image of the light source 1 formed on the substrate 3 by the imaging optical system 5. Note that the imaging optical systems 5 and 16 may be implemented by reflecting mirrors.

The aperture stop (first aperture stop) 13a and aperture stop (second aperture stop) 13b are used to change the spatial coherences of the measurement light and reference light, which form an image of interfering light on the image sensing surface of the image sensor 8, in accordance with a change in measurement mode (spatial coherence mode). The diameter (dimension) of the aperture of the aperture stop 13a is larger than that of the aperture of the aperture stop 13b. A mode in which the NAs (the numerical apertures, that is, the spatial coherence) of the measurement light and reference light are determined by the aperture stop 13a will be referred to as a low-coherence mode hereinafter, and that in which the NAs (that is, the spatial coherence) of the measurement light and reference light are determined by the aperture stop 13b will be referred to as a high-coherence mode hereinafter.

In response to a command to change the measurement mode to the high-coherence mode from the main controller 90, the coherence controller 10 controls an actuator ACT to move the aperture stop 13b to a position adjacent to the aperture stop 13a in the optical path of the measurement light and reference light. In response to a command to change the measurement mode to the low-coherence mode from the main controller 90, the coherence controller 10 controls the actuator ACT to retract the aperture stop 13b from the optical path. Upon this operation, in the low-coherence mode, the NAs (numerical apertures) of the measurement light and reference light are determined by the aperture stop 13a. Although the aperture stop 13a is fixed in the optical path, and the aperture stop 13b is inserted into or retracted from the optical path in this example, the aperture stop to be arranged in the optical path may be exchanged. The actuator ACT which drives the aperture stop 13b (or aperture stops 13a and 13b) can include at least one of, for example, a rotational mechanism and a translational mechanism. The actuator ACT can include at least one of, for example, a motor and an air cylinder as a driving source.

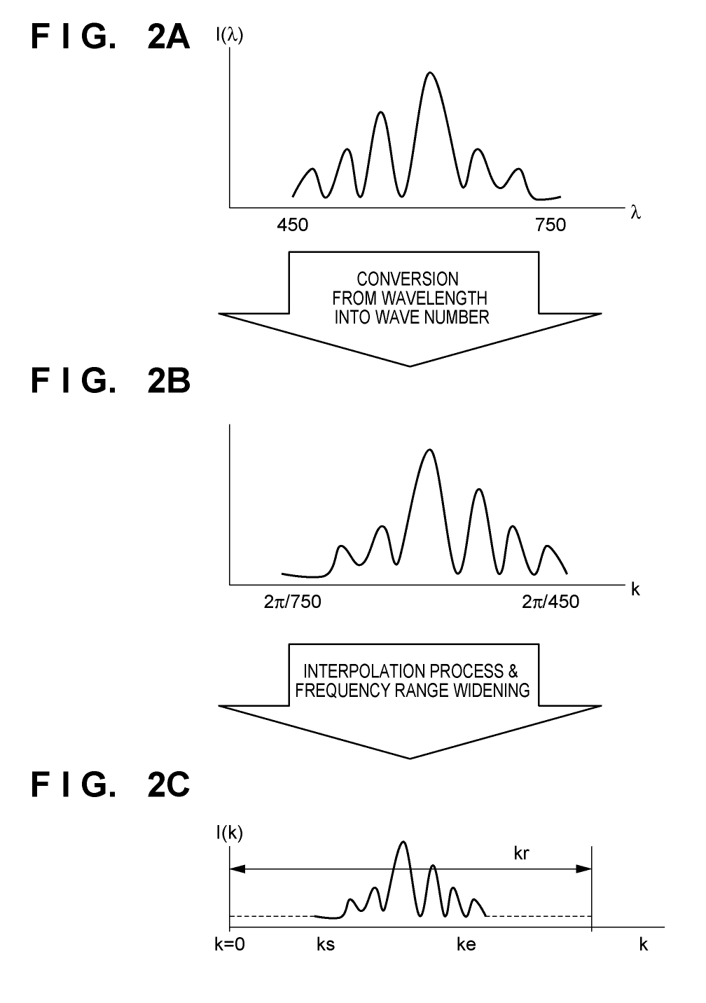

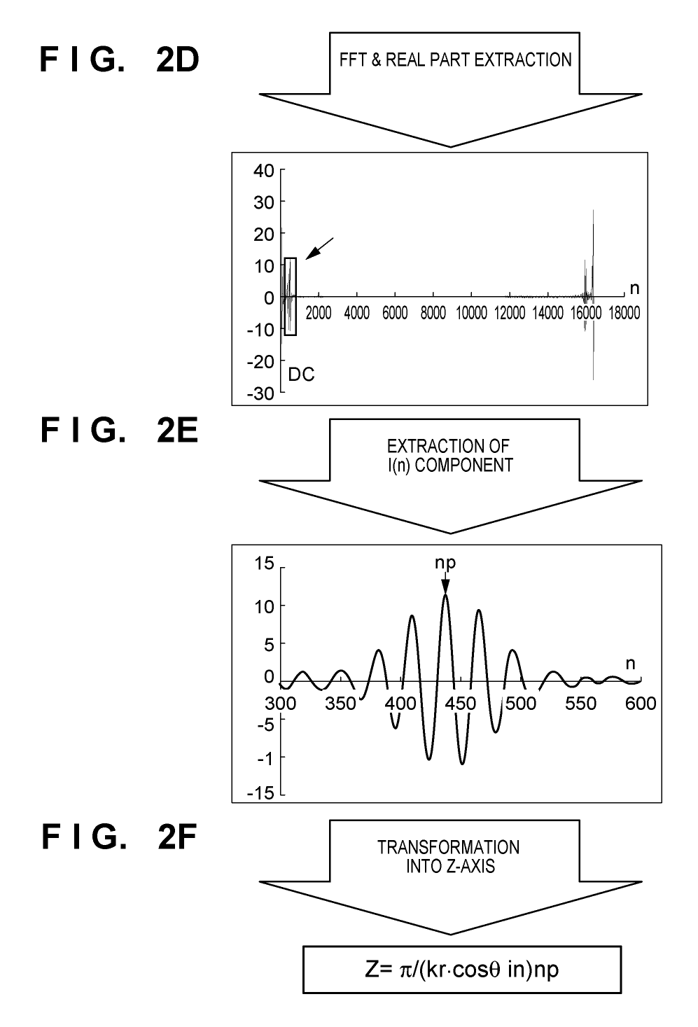

A method of processing by the calculating unit 9 a signal of spectrometric interfering light detected by the image sensor 8 to obtain the surface shape or surface position (level) of the substrate 3 or the resist coated on it will be described next. FIG. 2A illustrates a signal of spectrometric interfering light detected by the image sensor 8. FIG. 2A shows the wavelength (λ) on the abscissa and the light intensity on the ordinate. By dispersing interfering light into a plurality of wavelengths using the spectrometer 50, a signal of spectrometric interfering light obtained by converting the optical path length difference between the reference light and the measurement light into a difference in frequency can be detected by the image sensor 8. The calculating unit 9 converts the wavelength (λ) of the signal of spectrometric interfering light on the abscissa in FIG. 2A into a wave number (k) by an interpolation process, as shown in FIG. 2B, and then widens the frequency band up to kr, as shown in FIG. 2C. The initial point at this time is k=0. Note that the frequency band is widened so as to improve the pitch resolution upon transformation into a real space by subsequent Fourier transformation.

The calculating unit 9 performs a fast Fourier transformation (FFT) process of the spectrometric signal shown in FIG. 2C to extract its real part, as shown in FIG. 2D, and then extracts a necessary region from the real part, thereby obtaining a signal of white-light-interfering light having an optical path length difference in the real space, as shown in FIG. 2E. FIG. 2E shows the measurement value of the surface of the substrate in the height direction (Z-direction) on the abscissa, and the light intensity on the ordinate. FIG. 2E illustrates a so-called signal of white-light-interfering light upon Z scanning, and the surface position (level) of the substrate can be obtained by obtaining a peak position np of this signal of white-light-interfering light. Note that the known FDA technique (U.S. Pat. No. 5,398,113) can also be used as the method of measuring a peak position. In the FDA method, the peak position of a signal of interfering light is obtained using the phase gradient of a Fourier spectrum. In measurement which uses a white-light interferometer, its resolution depends on the accuracy of obtaining a position at which the optical path length difference between the reference light and the measurement light is zero. Hence, in addition to the FDA method, some fringe analysis methods such as the phase cross-correlation method and a method of obtaining the envelope of white-light-interference fringes by the phase shift method or the Fourier transformation method to obtain the zero-crossing point of the optical path difference from the maximum position of the fringe contrast have been proposed as known techniques and are applicable to the present invention. As shown in FIG. 2F, a practical level calculation equation is given by:

Z=π/(kr·cos(θin))·np (1)

where θin is the incident angle on the substrate, and kr is the frequency band.

Upon this operation, signals of spectrometric interfering light on the image sensor 8 corresponding to a plurality of positions in the X-direction on the substrate 3 shown in FIG. 1 are processed, thereby obtaining the surface position (level) of a slit-like region extending in the X-direction at a given position in the Y-direction on the substrate 3. By scanning the substrate 3 at a constant speed in the Y-direction by a substrate stage mechanism (not shown), the surface shape of the substrate 3 (the surface positions of the substrate 3 at a plurality of points within the two-dimensional plane) can be measured at a measurement pitch determined depending on the frame rate of the image sensor 8. Note that the size of the region in the X-direction, which can be measured simultaneously, is determined depending on the imaging magnification of the imaging optical system 16 and the size of the image sensor 8. Therefore, the entire surface shape of the substrate 3 can be measured by moving the substrate 3 in the X-direction in steps and then scanning it in the Y-direction, using the substrate stage mechanism (not shown) in accordance with the size of the object to be measured.

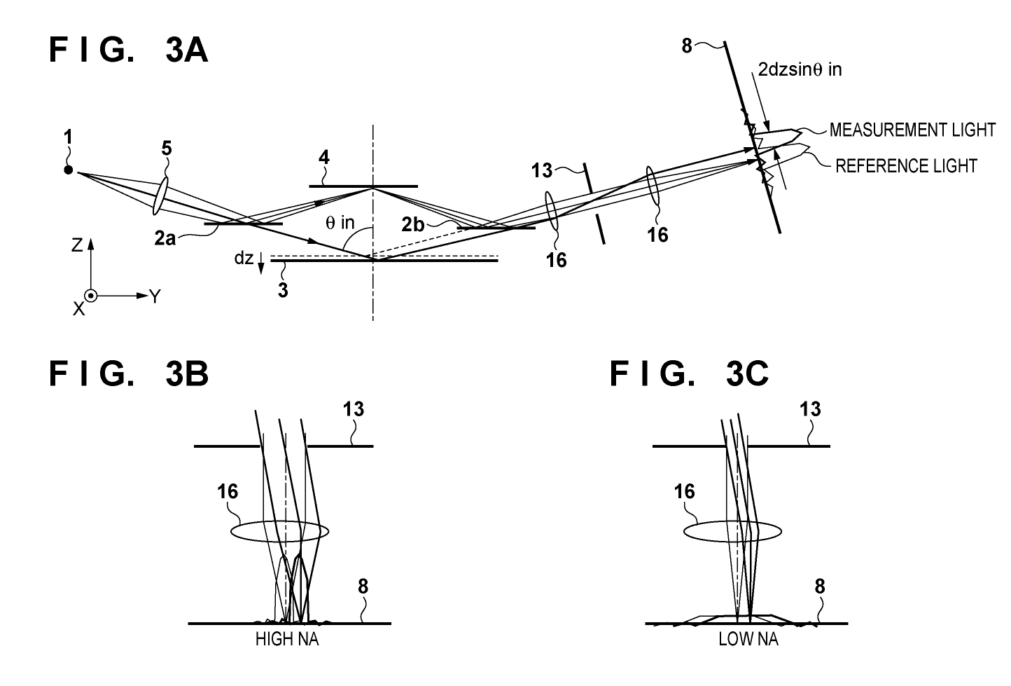

The purpose and principle of spatial coherence control will be explained next. The spatial coherence is controlled by controlling the numerical aperture (NA) of an imaging optical system including the aperture stop 13 and imaging optical system 16, as shown in FIGS. 3A to 3C. FIG. 3A shows the relationship between the spatial coherence and the numerical aperture (NA), and corresponds to the Y-Z plane shown in FIG. 1. Referring to FIG. 3A, light emitted by the low-coherence light source 1 strikes the substrate 3 and reference surface 4 upon passing through the imaging optical system 5 and beam splitter 2a, and forms an image on the image sensing surface of the image sensor 8 via the imaging optical system 16. Note that light which is directed to the substrate 3 and reflected by the substrate 3 is measurement light, and that light which is directed to the reference surface 4 and reflected by the reference surface 4 is reference light. An amount of displacement Z1 of the measurement light with respect to the reference light on the image sensing surface of the image sensor 8 upon a displacement of the substrate 3 by dz in the Z-direction (note that the imaging optical system 16 has unit imaging magnification for the sake of simplicity) is given by:

Z1=2d·z·sin(θin) (2)

where θin is the incident angle of the measurement light on the substrate 3. The low-coherence light source 1 can be considered as a group of point light sources. Therefore, light interference occurs only when light emitted by the same point light source is split into reference light and measurement light, and their point images are superposed on each other. A point image intensity distribution I(r) on the image plane of the imaging optical system 16 (the image sensing surface of the image sensor 8) is an intensity distribution generated by Fraunhofer diffraction by the circular aperture of the aperture stop 13 (aperture stop 13a or 13b), and is given by:

$$I ( r ) = {[ \frac{2 {J}_{1} ( \frac{2 π}{λ} NA r )}{\frac{2 π}{λ} NA r} ]}^{2} \qquad ( 3 )$$

where NA is the numerical aperture of the imaging optical system 16, r is the radius on the image plane, λ is the wavelength, and J₁ is a Bessel function of the first kind and first order, which is normalized assuming the peak intensity as 1. Further, a value r₀ of the radius r when the intensity of a diffracted image becomes zero for the first time is given by:

r₀=0.61λ/NA (4)

Equation (4) represents the radius of an Airy disk (Airy image). When the amount of displacement Z1 of the measurement light with respect to the reference light exceeds the diameter of the Airy disk, the point images of the reference light and measurement light are no longer superposed on each other, so no light interference occurs. From equations (2) and (4), the condition in which interference occurs is given by:

$$NA \leq \frac{0.61 λ}{sin ( θ in ) dz} \qquad ( 5 )$$

In equation (5), when a light source which emits light having broadband wavelengths is used, its central wavelength λc need only be substituted for λ (λ=λc).

Also, equation (5) represents the condition in which coherency disappears completely. In the range defined by equation (5) as well, a position displacement of the measurement light with respect to the reference light in the cross-section direction occurs due to a displacement of the substrate 3 in the height direction, thus degrading the coherency. As the coherency degrades, the contrast of a signal detected by the image sensor 8 lowers, and the S/N ratio of the signal also lowers. Hence, the condition in which a position displacement of the measurement light with respect to the reference light in the cross-section direction corresponds to the radius of the Airy disk can also be defined as:

$$NA \leq \frac{0.305 λ}{sin ( θ in ) dz} \qquad ( 6 )$$

FIG. 3B illustrates a point image intensity distribution in a mode in which the spatial coherence is low, that is, in a high-NA mode, and FIG. 3C illustrates a point image intensity distribution in a mode in which the spatial coherence is high, that is, in a low-NA mode. At a high NA, the peak intensity of the point image distribution function is relatively high but the radius of the Airy disk is short, so the range in which the measurement light and reference light are superposed on each other is narrow and the coherency is low. On the other hand, at a low NA, the amounts of blur of the point images are large, so the range in which the measurement light and reference light are superposed on each other is wide, but the peak intensity of the point image distribution function is low. For this reason, the high-coherence mode and the low-coherence mode are selectively used. In the high-coherence mode, a wide level range (Z-range) is obtained because the coherency is high, but the amount of light is small because the NA is low, so the measurement accuracy is relatively poor. The measurement accuracy is relatively poor in the high-coherence mode because the measuring process is susceptible to, for example, dark current noise, readout noise, and shot noise of the image sensor 8. Hence, it is preferable to use the high-coherence mode for coarse detection (prealignment). This is because in the high-coherence mode, an object to be measured having an unspecified level (surface position) can be measured in a wide level range, and the measurement accuracy need only be equal to that corresponding to the level range in the low-coherence mode. On the other hand, in the low-coherence mode, a narrow level range is obtained because the coherency is low, but the amount of light is large because the NA is high, so the measurement accuracy is good. In addition to this feature, since the coherency is relatively low, the shape of the front surface of a translucent film such as a resist can be more accurately measured by preventing interference between light reflected by the front surface of the translucent film and that reflected by the back surface of the translucent film.

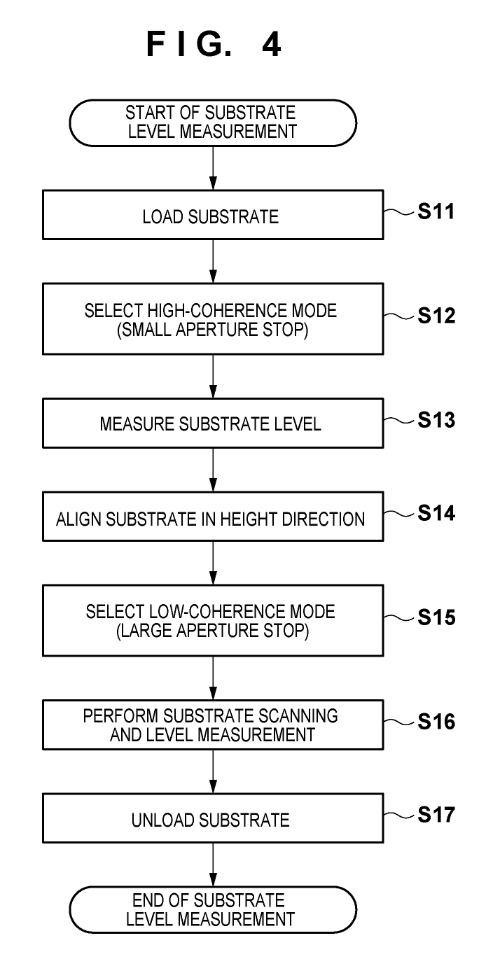

A measuring sequence in the measurement apparatus 33 will be exemplified below. FIG. 4 shows a measuring sequence in a first example. First, in step S11, a substrate (wafer) 3 to be measured is loaded into the measurement apparatus 33 and arranged on the stage of the substrate stage mechanism. In step S12, the aperture stop 13b is inserted into the optical path to select the high-coherence mode. In step S13, the position (level) of the surface of the substrate 3 (the surface of a resist when the resist is coated on the substrate 3) is measured. In step S14, the position of the substrate 3 is adjusted to that at which the level of the surface of the substrate 3 can be measured in the low-coherence mode, based on the information of the level measured in step S13. At this time, the position of the surface of the substrate 3 at one point defined on it can be measured in step S13, and the level of the substrate 3 can be adjusted based on the measurement value without changing the tilt of the substrate 3 in step S14. Alternatively, the levels of regions at three or more points on the substrate 3 may be measured in step S13, an approximate plane may be obtained by, for example, the least-squares method, and the level and tilt of the surface of the substrate 3 may be adjusted. In step S15, the aperture stop 13b is retracted from the optical path to select the low-coherence mode. In step S16, the position (level) of the surface of the substrate 3 (the surface of a resist when the resist is coated on the substrate 3) is measured while the substrate 3 is scanned at a constant speed in the Y-direction by the substrate stage mechanism. After the measurement of the entire region on the substrate 3 ends, the substrate 3 is unloaded from the measurement apparatus 33 in step S17, and the series of measurement ends.

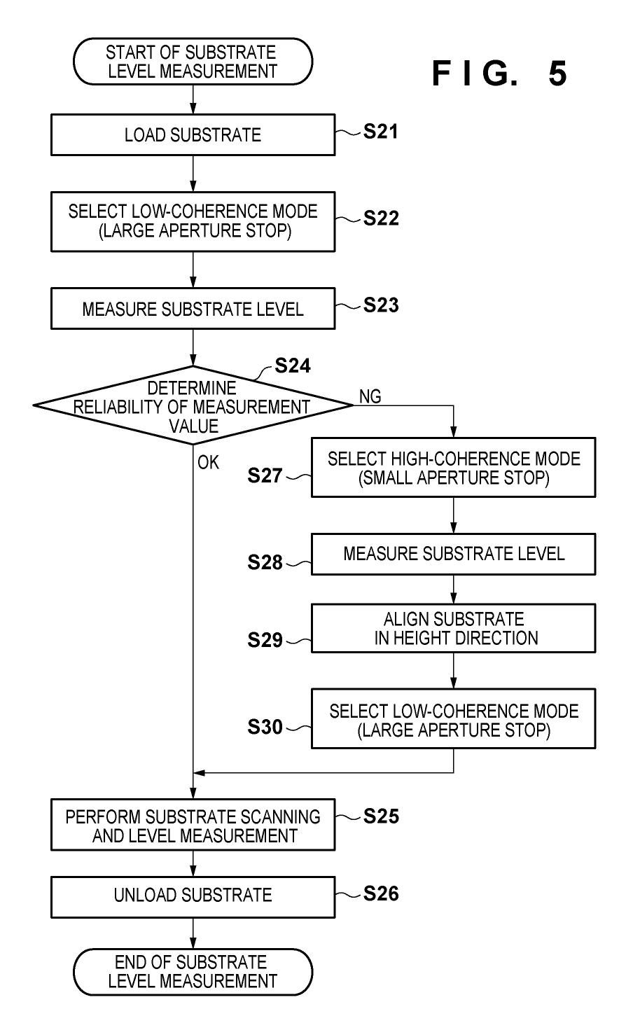

A measuring sequence in a second example will be described next with reference to FIG. 5. First, in step S21, a substrate (wafer) 3 to be measured is loaded into the measurement apparatus 33 and arranged on the stage of the substrate stage mechanism. In step S22, the state in which the NAs of the measurement light and reference light are determined by the aperture stop 13a (that is, the state in which the aperture stop 13b is retracted from the optical path) is set to select the high-coherence mode. In step S23, the position (level) of the surface of the substrate 3 (the surface of a resist when the resist is coated on the substrate 3) is measured. In step S24, the reliability of the measurement value obtained in step S23 is evaluated. More specifically, the contrast or S/N ratio of a signal of interfering light, the absolute value of the measurement value (the value of the measured level), or the amount of variation in measurement value (the amount of variation among several points obtained in step S23), for example, is evaluated. If it is determined as a result of evaluation in step S24 that the reliability is OK, the process advances to step S25, in which the position (level) of the surface of the substrate 3 (the surface of a resist when the resist is coated on the substrate 3) is measured while the substrate 3 is scanned at a constant speed by the substrate stage mechanism. On the other hand, if it is determined in step S24 that the reliability is NG, the measurement is interrupted, and the process advances to step S27. In step S27, the aperture stop 13b is inserted into the optical path to switch the spatial coherence mode to the high-coherence mode. In step S28, the position (level) of the surface of the substrate 3 (the surface of a resist when the resist is coated on the substrate 3) is measured. In step S29, the position of the substrate 3 is adjusted to that at which the level of the surface of the substrate 3 can be measured in the low-coherence mode, based on the information of the level measured in step S28. In step S30, the aperture stop 13b is retracted from the optical path to select the low-coherence mode. The process then advances to step S25, in which the position (level) of the surface of the substrate 3 (the surface of a resist when the resist is coated on the substrate 3) is measured while the substrate 3 is scanned at a constant speed in the Y-direction by the substrate stage mechanism. In the second example, the measurement throughput can be improved by measurement in the low-coherence mode in which the measurement accuracy is high from the beginning. The second example is useful when it is highly probable that the rough level of the surface of the substrate 3 is known.

The above-mentioned operation will be described below by taking concrete numerical values as an example. The numerical aperture (NA) in the low-coherence mode is set to sin(1°)=0.009, and that in the high-coherence mode is set to sin(0.05°)=0.0009. When the incident angle is set to 77°, and the central wavelength λ is set to 0.6 μm, the level of the surface of the substrate 3 can be measured within the range up to a substrate level displacement dz=21 μm in the low-coherence mode, as can be seen from equation (6). On the other hand, the level of the surface of the substrate 3 can be measured within the range up to a substrate level displacement dz=210 μm in the high-coherence mode, as can be seen from equation (6) as well. A variation in thickness of the substrate 3 can be measured with sufficient accuracy in the high-coherence mode because it generally falls within the range of ±100 μm.

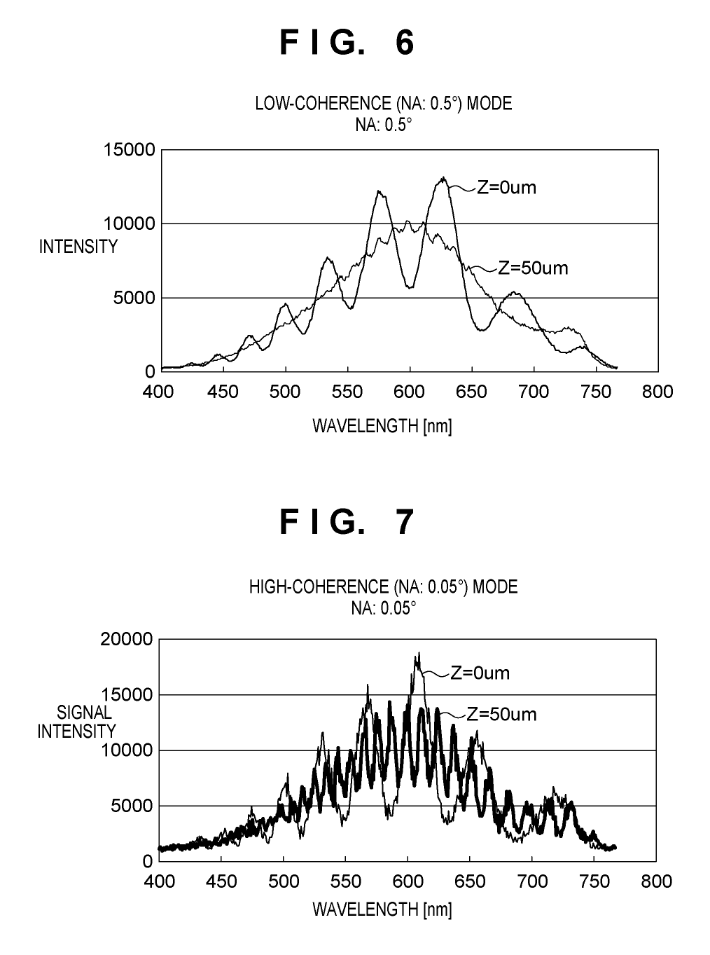

FIG. 6 illustrates spectrometric signals obtained in the low-coherence mode. More specifically, FIG. 6 illustrates the results of measuring the surface of the substrate 3 at levels z=0 and z=50 μm in the low-coherent mode. When z=0, the signal contrast was sufficient, so the measurement reproducibility was 5 nm (3σ). On the other hand, when z=50 μm, the signal contrast was very poor, so level measurement was impossible. Note that at a numerical aperture of 0.5°, a displacement between the reference light and the measurement light corresponds to the diameter of the Airy disk when z=50 μm.

FIG. 7 illustrates spectrometric signals obtained in the high-coherence mode. Sufficient signal contrast can be obtained even when the level of the substrate 3 shifts by 50 μm, as illustrated in FIG. 7. In the high-coherence mode, the NA is low and the amount of light is small, so the signal S/N ratio is lower than that in the low-coherence mode in FIG. 6 when z=0, but the measurement reproducibility is 20 nm (3σ) when z=0, and is 30 nm (3σ) when z=50 μm.

In this manner, the numerical apertures, that is, NAs in the high- and low-coherence modes can be designed based on, for example, the uncertainty dz of the level of the surface to be measured, the incident angle θin, and the wavelength band used.

Note that the aperture stop used in the low-coherence mode is fixed and that used in the high-coherence mode is movable, because the incident angle on the substrate 3 changes upon a change in position of the aperture stop and this change generates a measurement error. Since the high-coherence mode is used for coarse detection, an error due to a fluctuation in position of the aperture stop falls within a tolerance.

Although critical illumination is adopted as the illumination scheme in the configuration shown in FIG. 1, the same effect can be obtained when Kohler illumination is adopted as well. FIGS. 11A and 11B show the arrangements of critical illumination and Kohler illumination, respectively. FIG. 11A is a view showing the arrangement of critical illumination. Two lenses A and B having a focal length f1 are used so that a light source 1 is arranged at the front focal position of lens A and an aperture stop is arranged at the back focal position of lens A. Also, lens B is arranged so that its front focal position coincides with the back focal position of lens A, and a substrate 3 is arranged so that its surface position coincides with the vicinity of the back focal position of lens B. On the other hand, FIG. 11B is a view showing the arrangement of Kohler illumination. The arrangement which adopts Kohler illumination includes a light source 1, lens C having a focal length f2, lens D having a focal length f3, lens E having the focal length f3, a field stop, and an aperture stop. The light source 1 is arranged at the front focal position of lens C, and the field stop is arranged at the back focal position of lens C. Also, lens D is arranged so that its front focal position coincides with the back focal position of lens C, and the aperture stop is arranged at the back focal position of lens D. Moreover, lens E is arranged so that its front focal position coincides with the back focal position of lens D, and the substrate 3 is arranged so that its surface position coincides with the vicinity of the back focal position of lens E.

Although the aperture stops 13a and 13b are arranged in the imaging optical system 16 on the light reception side in the configuration shown in FIG. 1, they may be arranged in the imaging optical system 5 on the illumination side.

Also, although two spatial coherences can be selectively used in the configuration shown in FIG. 1, a configuration capable of selectively using three or more spatial coherences can be formed by providing three or more aperture stops. Moreover, the spatial coherence may be set variable by adopting an iris diaphragm capable of changing the dimension of the aperture of the aperture stop continuously or stepwise.

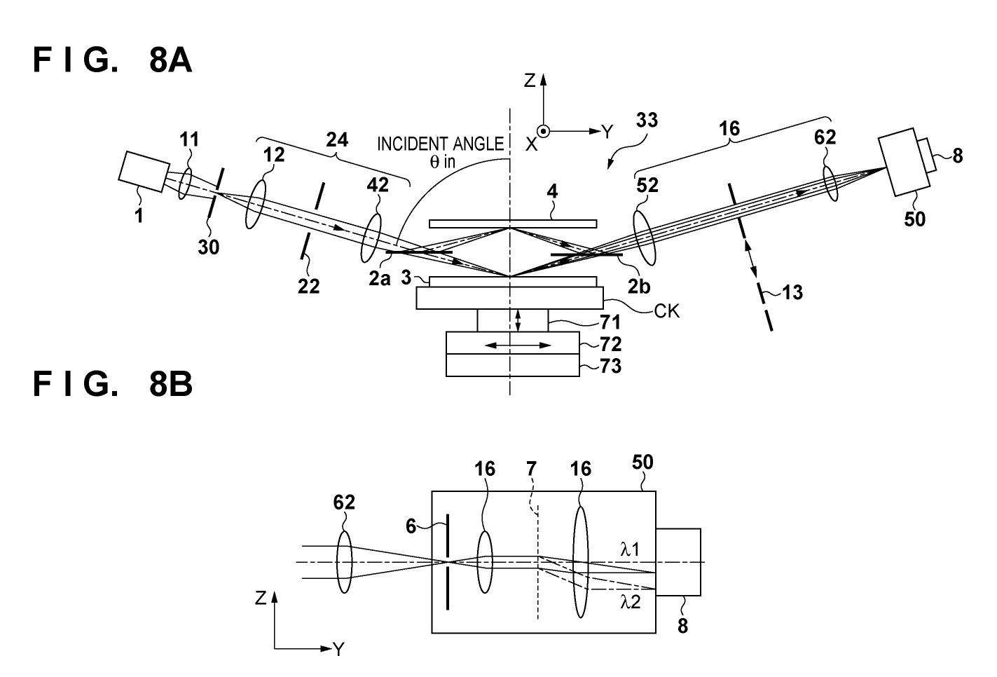

A measurement apparatus 33 according to the second embodiment of the present invention will be described below with reference to FIGS. 8A and 8B. Note that details which are not particularly referred to in the second embodiment can be the same as in the first embodiment. Light emitted by a light source 1 passes through a transmissive slit plate 30 upon being focused by a condenser lens 11, and enters an imaging optical system 24 formed by lenses 12 and 42. The light having passed through the imaging optical system 24 is split by a beam splitter 2a into two nearly half light beams, which strike a substrate 3 and a reference surface 4, respectively, by oblique incidence. Note that the imaging optical system 24 forms an image of the slit in the transmissive slit plate 30 on each of the substrate 3 and reference surface 4. The transmissive slit plate 30 is useful in blocking stray light and defining the measurement range.

Measurement light reflected by the substrate 3 and reference light reflected by the reference surface 4 are combined into combined light (interfering light) by a beam combiner 2b, and the combined light enters a spectrometer 50 upon passing through an imaging optical system 16 including lenses 52 and 62. Note that the slit images formed on the substrate 3 and reference surface 4 are formed in an entrance slit 6 in the spectrometer 50 by the imaging optical system 16 again. That is, the transmissive slit plate 30, the substrate 3 and reference surface 4, and the entrance slit 6 in the spectrometer 50 are set in an optically conjugate relationship by the imaging optical systems 24 and 16. The combined light having passed through the entrance slit 6 enters a spectrometric element 7. The spectrometric element 7 is implemented by a diffraction grating and separates the combined light into light beams with different wavelengths in the widthwise direction of the entrance slit 6. The light having passed through the spectrometric element 7 strikes the image sensing surface of an image sensor 8 to form an image on this image sensing surface. That is, the image sensor 8 detects a signal of spectrometric interfering light as one-dimensional position information and wavelength information, as in the first embodiment. In the second embodiment, the spectrometer 50 includes the entrance slit 6, spectrometric element 7 (for example, a diffraction grating), and the imaging optical system 16.

The aperture stop 22 is fixed in the pupil of the imaging optical system 24 on the light projection side, and an aperture stop 13 is selectively arranged in the pupil of the imaging optical system 16 on the light reception side in accordance with whether the spatial coherence mode is the high-coherence mode or the low-coherence mode. The dimension (diameter) of an aperture stop 22 in the imaging optical system 24 on the light projection side is larger than that of an aperture stop 13 in the imaging optical system 16 on the light reception side. The aperture stop 13 is inserted into or retracted from the optical path by an actuator (not shown). Only the aperture stop 22 is used in the low-coherence mode, and the aperture stop 13 is used upon being arranged in the optical path in the high-coherence mode. In contrast to this, it is also possible to adopt a configuration in which an aperture stop is selectively arranged in the pupil of the imaging optical system 24 on the light projection side in accordance with the measurement mode, and another aperture stop is fixed in the pupil of the imaging optical system 16 on the light reception side.

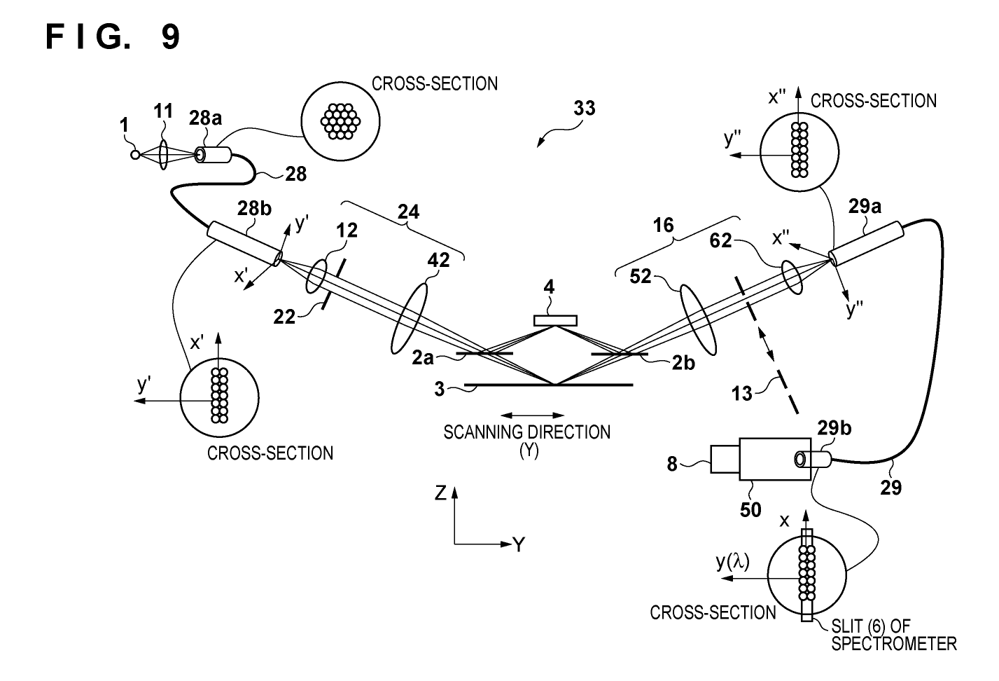

A measurement apparatus 33 according to the third embodiment of the present invention will be described below with reference to FIG. 9. Note that details which are not particularly referred to in the third embodiment can be the same as in the first and second embodiments. In the third embodiment, bundled fibers are used on the light projection side and light reception side. Light emitted by a light source 1 is focused by a condenser lens 11 and enters a bundled fiber 28. The light emerging from the bundled fiber 28 enters an imaging optical system 24 formed by lenses 12 and 42. The light having passed through the imaging optical system 24 is split by a beam splitter 2a into two nearly half light beams, which strike a substrate 3 and a reference surface 4, respectively, by oblique incidence. Measurement light reflected by the substrate 3 and reference light reflected by the reference surface 4 are combined into combined light (interfering light) by a beam combiner 2b. The combined light enters a bundled fiber 29 upon passing through an imaging optical system 16 including lenses 52 and 62, and enters an image sensor 8 via the bundled fiber 29 and eventually a spectrometer 50. The spectrometer 50 can have the same configuration as that in the second embodiment.

At an entrance end 28a of the bundled fiber 28, fiber wires are bundled in a nearly circular shape, as shown in FIG. 9, so light can be efficiently received from the light source 1. On the other hand, at an exit end 28b of the bundled fiber 28, fiber wires are bundled in a rectangular shape. This makes it possible to freely arrange the light source 1 at a position spaced apart from the imaging optical system 24, thereby reducing the adverse thermal effect that the light source 1 exerts on the imaging optical system 24. Further, varying the array of wires of the bundled fiber 28 in the interval from the entrance end 28a to the exit end 28b provides the same function as that of the transmissive slit plate 30 described in the second embodiment. The imaging optical system 24 can be implemented as, for example, an enlargement optical system, and guide measurement light onto the substrate 3 in a wide range in the X-direction.

Sets of fiber wires of an entrance end 29a and exit end 29b of the bundled fiber 29 are connected straight to each other, so both the entrance end 29a and exit end 29b have the same rectangular shape as that of the exit end 28b of the bundled fiber 28. The bundled fiber 29 guides interfering light to the spectrometer 50. The position of an entrance slit 6 in the spectrometer 50 coincides with that of the exit end 29b of the bundled fiber 29. Alternatively, the rectangular shape of the exit end 29b of the bundled fiber 29 itself may serve as an entrance slit in a spectrometer.

With such a configuration, the spectrometer 50 and image sensor 8 can be freely arranged at positions spaced apart from the imaging optical system 16. The imaging optical system 16 on the light reception side is implemented as, for example, a reduction optical system, and reduces and projects the measurement region (X-direction) on the substrate 3 onto the bundled fiber 29, spectrometer 50, and image sensor 8. This makes it possible to widen the measurement region in the X-direction and, in turn, to shorten the time taken to measure the entire region on the substrate 3.

A method of controlling or changing the spatial coherence is the same as in the second embodiment. That is, the diameter (dimension) of an aperture stop 22 in the imaging optical system 24 on the light projection side is larger than that of an aperture stop 13 in the imaging optical system 16 on the light reception side. Only the aperture stop 22 is used in the low-coherence mode, and the aperture stop 13 is used upon being arranged in the optical path in the high-coherence mode. The aperture stop 22 is fixed in the pupil of the imaging optical system 24 on the light projection side, and the aperture stop 13 is selectively arranged in the pupil of the imaging optical system 16 on the light reception side in accordance with whether the spatial coherence mode is the high-coherence mode or the low-coherence mode. In contrast to this, it is also possible to adopt a configuration in which an aperture stop is selectively arranged in the pupil of the imaging optical system 24 on the light projection side in accordance with the measurement mode, and the other aperture stop is fixed in the pupil of the imaging optical system 16 on the light reception side.

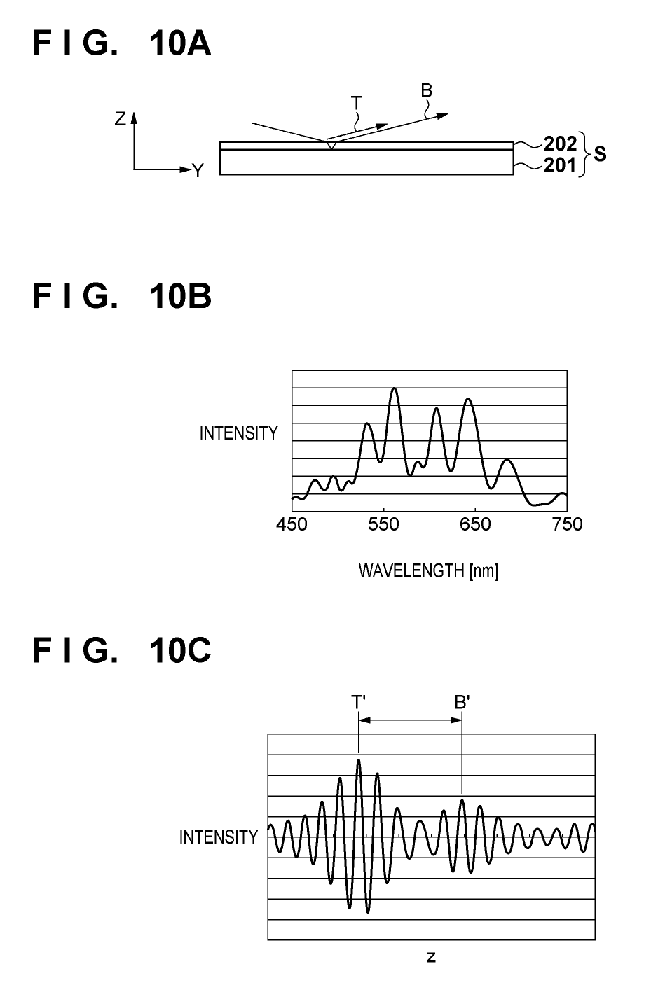

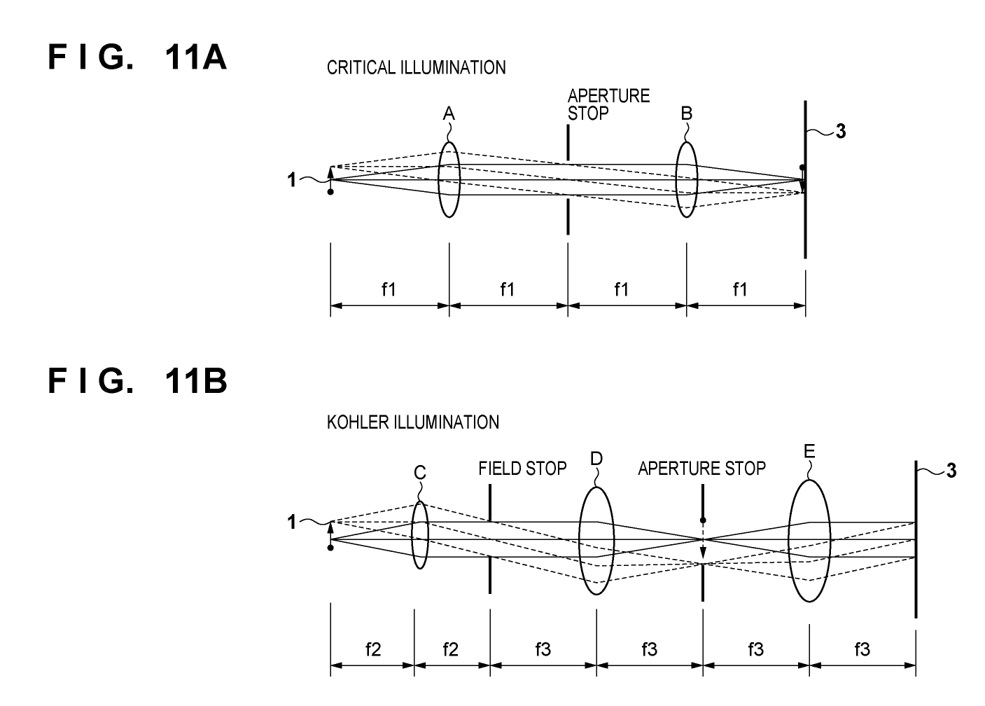

A measurement apparatus according to the fourth embodiment of the present invention will be described below with reference to FIGS. 10A to 10C. The measurement apparatus according to the fourth embodiment is configured to measure the thickness distribution or thickness of a translucent film formed on a substrate. FIG. 10A illustrates a sample S as an object to be measured. The sample S includes an Si substrate 201 and an SiO₂ film 202 formed on the Si substrate 201, and the thickness distribution or thickness of the SiO₂ film 202 is to be measured. The measurement apparatus 33 according to any one of the first to third embodiments can be directly used as that according to the fourth embodiment. First, the measurement apparatus 33 measures the surface position (level) of the sample S in the high-coherence mode, and uses a substrate stage mechanism to adjust the level of the surface of the sample S based on the measurement value so that this surface position falls within the measurement range in the low-coherence mode. The measurement apparatus 33 then changes the measurement mode from the high-coherence mode to the low-coherence mode to obtain a signal of spectrometric interfering light while scanning the sample S in the Y-direction. FIG. 10B illustrates a signal of spectrometric interfering light obtained from a sample S having a 1.5-μm thick SiO₂ film 202 formed on the Si substrate 201. FIG. 10C illustrates a signal obtained by the signal processing described with reference to FIGS. 2A to 2F, that is, a signal of white-light-interfering light having a given optical path length difference in a real space (a so-called signal of white-light-interfering light upon Z scanning).

Referring to FIG. 10C, the signal of white-light-interfering light includes two peaks T′ and B′. The peak T′ is generated when the optical path length of measurement light T reflected by the surface of the SiO₂ film 202 coincides with that of reference light reflected by a reference surface 4, as shown in FIG. 10A. The peak B′ is generated when the optical path length of measurement light B reflected by the interface between the SiO₂ film 202 and the Si substrate 201 coincides with that of reference light reflected by the reference surface 4, as shown in FIG. 10A. Letting n be the refractive index of the SiO₂ film 202, and d be the thickness of the SiO₂ film 202, the optical path length difference between the measurement light T and the measurement light B is 2n·d·cos θ. According to Snell's law, we have:

sin(θ)=n·sin(θin) (8)

where θ is the angle of refraction at the interface between the air and the SiO₂ film 202, and θin is the incident angle.

On the other hand, the optical path length difference upon a change in position of the substrate 3 in the Z-direction is 2(B′−T′)cos θin, so both the optical path length differences are equal to each other. From this relationship, the thickness d of the SiO₂ film 202 is given by:

$$d = \frac{( {B}^{′} - {T}^{′} ) cos ( θ in )}{n cos ( θ )}$$

The positions of the peaks B′ and T′ can be accurately obtained using a method such as fitting based on a quadratic function. Also, the thickness distribution of the translucent film (SiO₂ film) on the sample S can be accurately measured by scanning the sample S at a constant speed in the Y-direction using the substrate stage mechanism.

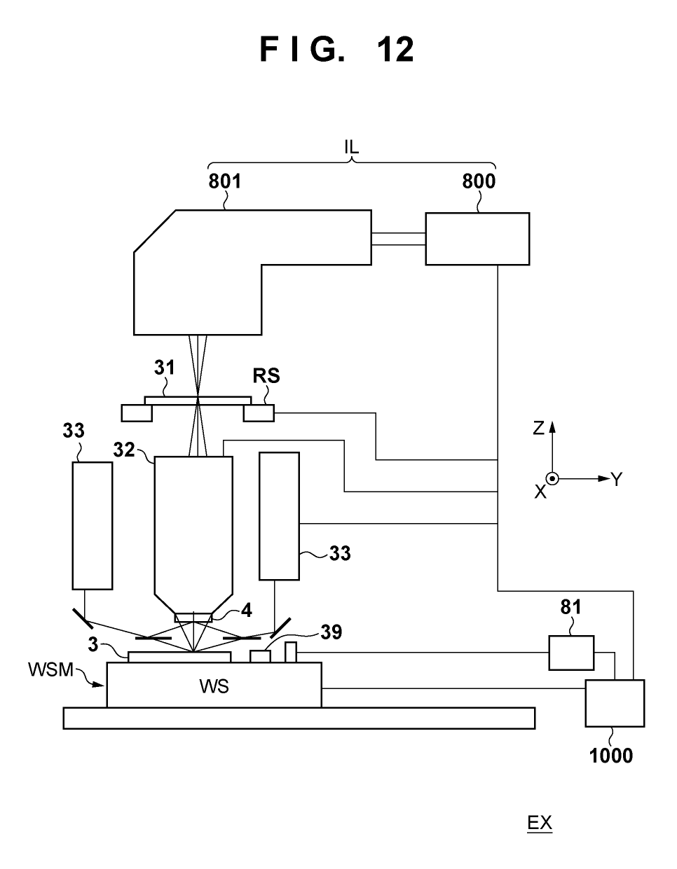

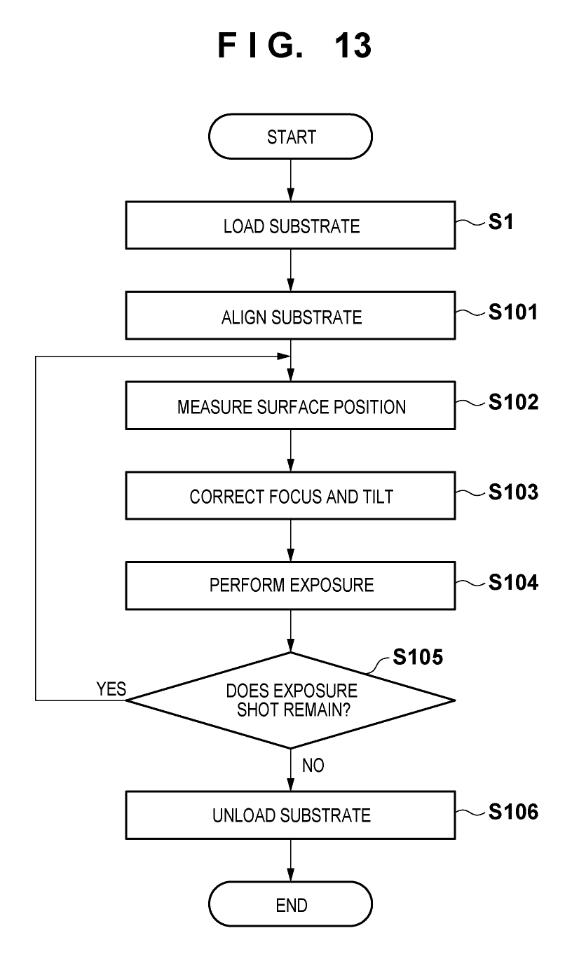

An exposure apparatus EX according to the fifth embodiment of the present invention will be described below with reference to FIG. 12. The above-mentioned measurement apparatus 33 is built into the exposure apparatus EX. The exposure apparatus EX includes, for example, an illumination system IL, original stage mechanism RSM, projection optical system 32, substrate stage mechanism WSM, and controller 1000. The controller 1000 controls the illumination system IL, original stage mechanism RSM, projection optical system 32, substrate stage mechanism WSM, and measurement apparatus 33. The final surface (flat surface) of the projection optical system 32 can be used as a reference surface 4 of the measurement apparatus 33. The illumination system IL includes a light source unit 800 and an illumination optical system 801 which illuminates an original (reticle) 31 with light supplied from the light source unit 800. The light source unit 800 can be, for example, a laser. The laser can be an ArF excimer laser which emits light having a wavelength of about 193 nm, or a KrF excimer laser which emits light having a wavelength of about 248 nm, but the type of light source is not limited to an excimer laser. An F₂ laser which emits light having a wavelength of about 157 nm, or an EUV (Extreme Ultraviolet) light source which emits light having a wavelength of 20 nm or less, for example, can also be adopted.

The illumination optical system 801 shapes the cross-section of a light beam emitted by the light source unit 800 into a slit, and illuminates the original (reticle) 31 with the light beam. The illumination optical system 801 can include, for example, a lens, mirror, optical integrator, and stop. The illumination optical system 801 can be configured by arranging optical elements in the order of, for example, a condenser lens, a fly-eye lens, an aperture stop, a condenser lens, a slit, and an imaging optical system.

The original 31 can be configured by arranging a light-shielding portion on, for example, a quartz plate. The original 31 is positioned by the original stage mechanism RSM. Light diffracted by the original 31 illuminated by the illumination system IL is directed to a substrate 3 by the projection optical system 32 to form an image of the pattern of the original 31 on the substrate 3. The original 31 and substrate 3 are arranged at optically conjugate positions. The pattern of the original 31 is transferred onto the substrate 3 (its resist) by scanning them at a speed ratio corresponding to the reduction magnification ratio of the projection optical system 32. The position of the original 31 can be measured by an original detector (not shown), and controlled by the original stage mechanism RSM based on the measurement result. The original stage mechanism RSM can include, for example, an original stage including an original chuck which holds the original 31, and a driving mechanism which drives the original stage. The original stage mechanism RSM can position the original 31 in six axial directions: the X-, Y-, and Z-directions and rotation directions about these respective axes.

The projection optical system 32 forms an image of a light beam from the object plane, on which the original 31 is arranged, on the image plane on which the substrate 3 is arranged. The projection optical system 32 can be, for example, an optical system including a plurality of lens elements, that (catadioptric system) including a plurality of lens elements and at least one concave mirror, or that including a plurality of lens elements and at least one diffractive optical element such as a kinoform.

The substrate 3 can have a structure formed by arranging a photoresist on the surface of a plate such as a wafer or a glass substrate. The substrate stage mechanism WSM can include, for example, a substrate stage WS including a substrate chuck which holds the substrate 3, and a driving mechanism which drives the substrate stage WS. The substrate stage mechanism WSM can position the substrate 3 in six axial directions: the X-, Y-, and Z-directions and rotation directions about these respective axes. The positions of the original 31 and substrate 3 can be measured by a measurement device 81 such as a laser interferometer, and they can be driven at a predetermined speed ratio based on the measurement result. A reference plate 39 is placed on the substrate stage WS.

The substrate 3 is controlled so that its surface coincides with the image plane of the projection optical system 32 during exposure. Note that the surface position (level) of the substrate 3 is measured by the measurement apparatus 33, and the substrate 3 is driven by the substrate stage mechanism WSM based on the measurement result so that this surface position coincides with the image plane of the projection optical system 32. The sequence of measuring the surface position of the substrate 3 can include repetitions of scanning measurement in which the surface position of the substrate 3 is measured while it is scanned in the scanning direction (Y-direction), and step movement in which the substrate 3 is moved in a direction (X-direction) perpendicular to the scanning direction so as to change the measurement region. To improve the measurement throughput, a plurality of measurement apparatuses 33 may be used to measure the surface positions of different regions on the substrate 3 in parallel. Also, a plurality of measurement apparatuses 33 may be used to measure the surface positions of different regions on the substrate 3 in parallel to detect the tilt of the surface of the substrate 3 based on the measurement result.

A method of exposing a substrate by the exposure apparatus EX according to the fifth embodiment shown in FIG. 12 will be described next with reference to FIG. 13. This exposing method can be controlled by the controller 1000. First, a substrate (wafer) 3 is loaded into the exposure apparatus EX in step S1, and alignment (more specifically, measurement for alignment) of the substrate 3 is performed in step S101. In this case, the positions of marks on the substrate 3 are detected by an alignment scope (not shown) to obtain the positional relationship between the substrate 3 and the original 31 based on the detection result.

In step S102, the measurement apparatus 33 measures the surface position (level) of the substrate 3, generates surface shape data of the substrate 3, and stores it in a memory in the controller 1000. In step S103, the substrate stage mechanism WSM positions the substrate 3 at a position at which scanning of the shot region to be exposed starts. At this time, the controller 1000 causes the substrate stage mechanism WSM to control the position in the Z-direction and the tilt of the substrate 3 based on the surface shape data of the substrate 3 so as to reduce the amount of shift of the surface of the substrate 3 from the image plane of the projection optical system 32. In step S104, the shot region to be exposed undergoes scanning exposure. In this scanning exposure, the controller 1000 causes the substrate stage mechanism WSM to control the position in the Z-direction and the tilt of the substrate 3 so as to reduce the amount of shift of the surface of the substrate 3 from the image plane of the projection optical system 32. This makes it possible to match the surface of the substrate 3 with the image plane of the projection optical system 32 in synchronism with scanning of the substrate 3, in scanning exposure of each shot region. In step S105, the controller 1000 determines whether a shot region to be exposed (that is, an unexposed shot region) remains. The controller 1000 then repeats the processes in steps S102 to S104 until no unexposed shot region remains. After exposure of all exposure shot regions ends, the substrate 3 is unloaded in step S106.

Since a complex circuit pattern and scribe lines, for example, are present on the substrate 3, a reflectance distribution or a local tilt, for example, can occur in the substrate 3. Hence, surface shape measurement which uses a white-light interferometer capable of reducing a measurement error due to the reflectance distribution and local tilt is useful. In step S102, the level of the surface of the substrate 3 can be measured in the high-coherence mode, the substrate 3 can be positioned in the Z-direction based on the measured level information, and the surface shape of the substrate 3 can be measured while it is scanned in the low-coherence mode. This method obviates the need to additionally use a focus sensor for coarsely detecting the level of the substrate 3, thus simplifying the system configuration of the exposure apparatus EX and reducing its cost. Also, this method improves the accuracy of alignment (focusing) between an optimum exposure surface and a substrate surface, thus improving both the manufacturing yield and the performance of a device such as a semiconductor device.

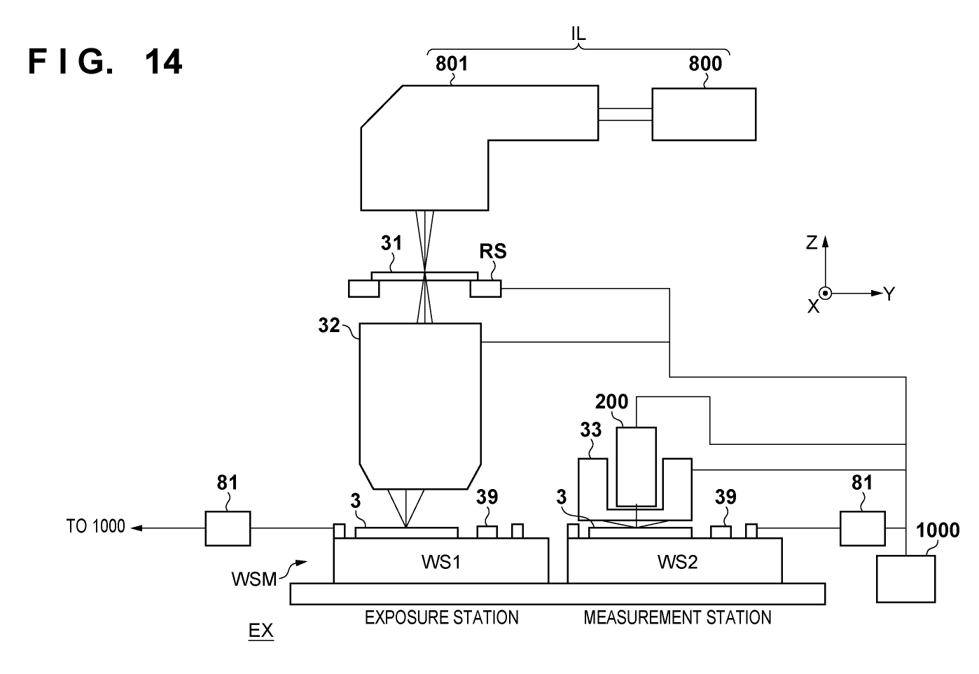

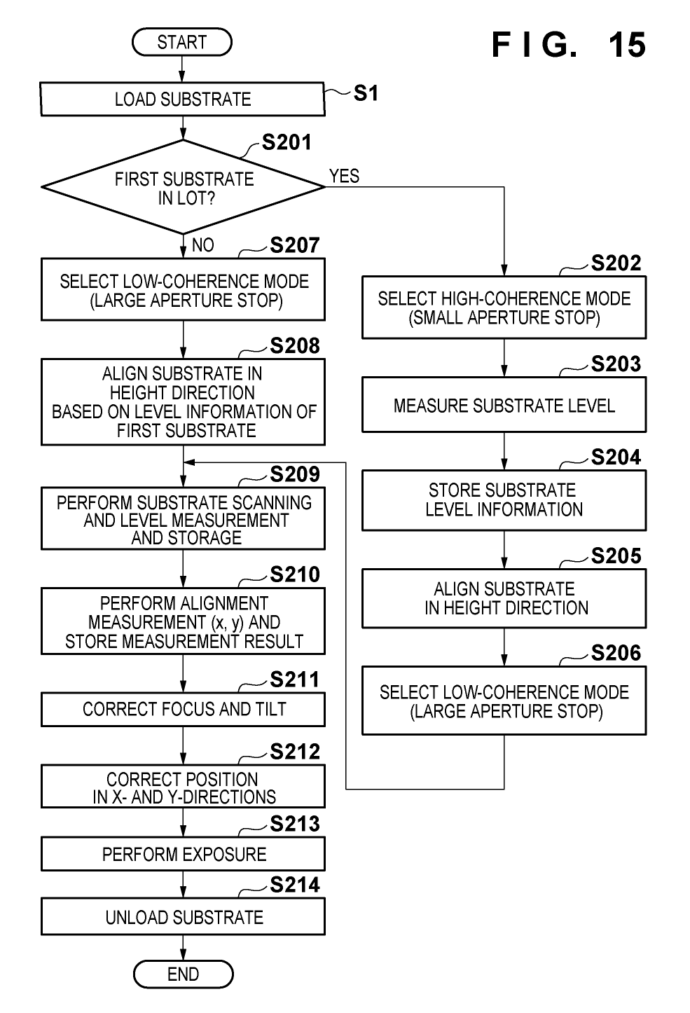

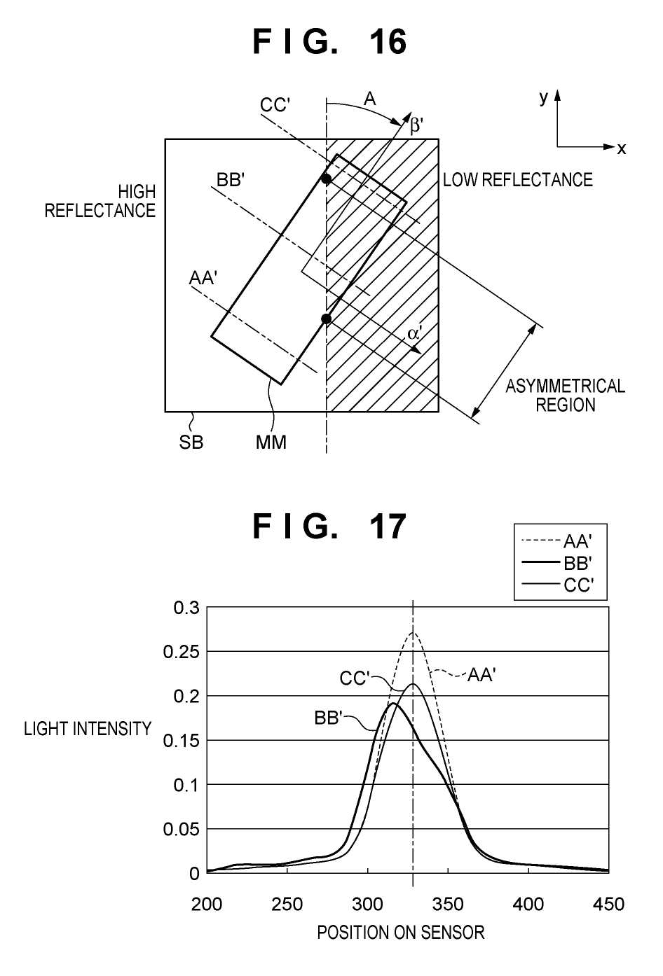

An exposure apparatus EX according to the sixth embodiment of the present invention will be described below with reference to FIG. 14. Note that details which are not particularly referred to herein can be the same as in the fifth embodiment. In the sixth embodiment, a substrate stage mechanism WSM has a twin-stage configuration. More specifically, the exposure apparatus EX includes an exposure station in which a substrate is exposed, and a measurement station in which the substrate is measured. In the exposure station, a substrate is exposed upon being positioned based on the result of measurement in the measurement station. The substrate stage mechanism WSM includes substrate stages WS1 and WS2, and a substrate 3 held by one substrate stage is measured in the measurement station while a substrate 3 held by the other substrate stage is exposed in the exposure station. The substrate stages WS1 and WS2 are provided with reference plates 39.

An illumination system IL, an original stage mechanism RSM, and a projection optical system 32 are arranged in the exposure station, and a measurement apparatus 33 and an alignment detection system 200 which measures the positions of marks on the substrate 3 are arranged in the measurement station. Note that the measurement apparatus 33 according to any one of the first to third embodiments can be provided.

A method of exposing a substrate by the exposure apparatus EX according to the sixth embodiment shown in FIG. 14 will be described next with reference to FIG. 15. This exposing method can be controlled by a controller 1000. In step S1, a substrate (wafer) 3 is loaded into the exposure apparatus EX. In step S201, the controller 1000 determines whether the loaded substrate 3 is the first substrate in a lot. If the loaded substrate 3 is the first substrate in the lot, the controller 1000 advances the process to step S202; otherwise, it advances the process to step S207. In step S202, the controller 1000 sets the measurement mode of the measurement apparatus 33 to the high-coherence mode. The controller 1000 executes a process of measuring the surface position (level) of the substrate 3 in step S203, and stores the measurement value obtained by the measuring process in step S204. In step S205, the controller 1000 operates the substrate stage mechanism WSM based on the measurement value obtained in step S204, so that the level of the surface of the substrate 3 falls within the measurement range in the low-coherence mode. In step S206, the controller 1000 switches the measurement mode of the measurement apparatus 33 to the low-coherence mode, and advances the process to step S209.

In step S209, the controller 1000 obtains a signal of spectrometric interfering light using the measurement apparatus 33 while scanning the substrate 3 to obtain a measurement value z of the level of the surface of the substrate 3 based on the signal of spectrometric interfering light, and stores the measurement value z. In step S210, the controller 1000 uses the alignment detection system 200 to detect the positions of alignment marks formed in a plurality of portions on the substrate 3 to calculate the position of each shot region on the substrate 3, and stores the calculation result.

If the controller 1000 determines in step S201 that the loaded substrate 3 is not the first substrate in the lot, it sets the measurement mode of the measurement apparatus 33 to the low-coherence mode in step S207. In step S208, the controller 1000 operates the substrate stage mechanism WSM based on the level measurement value of the first substrate 3 in the same lot, which is stored in step S204, so that the level of the surface of the substrate 3 falls within the measurement range in the low-coherence mode. In step S209, the controller 1000 obtains a signal of spectrometric interfering light using the measurement apparatus 33 while scanning the substrate 3 to obtain a measurement value z of the level of the surface of the substrate 3 based on the signal of spectrometric interfering light, and stores the measurement value z. In step S210, the controller 1000 uses the alignment detection system 200 to detect the positions of alignment marks formed in a plurality of portions on the substrate 3 to calculate the position of each shot region on the substrate 3, and stores the calculation result. In this case, the thicknesses of substrates 3 vary across individual lots, but the differences in thickness between substrates 3 in the same lot are very small, so level measurement in the high-coherence mode can be omitted for the second and subsequent substrates 3 in each lot by using the level information of the surface of the first substrate 3 in this lot. Note that in measurement of the low-coherence mode in step S209, if the measurement value or signal has an abnormality, a sequence (for example, a series of processes in steps S24 to S30 in FIG. 5) of changing the measurement mode of the measurement apparatus 33 to the high-coherence mode to perform coarse detection may be added.

A process in the measurement station has been described above. After the process in the measurement station ends, the substrate stage present in the measurement station moves to the exposure station, and that present in the exposure station moves to the measurement station. In step S211, the controller 1000 causes the substrate stage mechanism WSM to control the level (Z) and tilt (ωx, ωy) of the substrate 3 based on the level measurement value of the substrate 3 obtained in step S209, so that the surface of the substrate 3 coincides with the optimum imaging plane of the projection optical system 32. Parallel to this operation, in step S212, the controller 1000 controls the substrate stage mechanism WSM to drive the substrate 3 at a constant speed in the Y-direction while correcting the position of the substrate 3 in the X- and Y-directions based on the position information of each shot region on the substrate 3 measured in step S210. Parallel to this operation, in step S213, the pattern of an original 31 is projected onto the substrate 3 by the projection optical system 32 to perform scanning exposure of the substrate 3. As is apparent from the foregoing description, the operations in steps S211, S212, and S213 are executed in parallel. After exposure of all the shot regions on the substrate 3 ends, the substrate 3 is unloaded from the exposure apparatus EX in step S214.

A method of manufacturing a device according to a preferred embodiment of the present invention is suitable for manufacturing a device such as a semiconductor device or a liquid crystal device. This method can include a step of exposing a substrate coated with a photosensitive agent to light using the above-mentioned exposure apparatus, and a step of developing the exposed substrate. This method can also include subsequent known steps (for example, oxidation, film formation, vapor deposition, doping, planarization, etching, resist removal, dicing, bonding, and packaging).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-160300, filed Jul. 21, 2011, which is hereby incorporated by reference herein in its entirety.

What is claimed is:

1. A measurement apparatus which includes a beam splitter that splits light from a light source into measurement light to be directed to an object to be measured and reference light to be directed to a reference surface, and a beam combiner that combines the measurement light reflected by the object and the reference light reflected by the reference surface to generate combined light, and obtains physical information of the object based on the combined light, the apparatus comprising:
a coherence controller which changes spatial coherences of the measurement light and the reference light.

2. The apparatus according to claim 1, wherein the spatial coherence is determined depending on a dimension of an aperture of an aperture stop to be arranged in an optical path of the measurement light and the reference light.

3. The apparatus according to claim 1, wherein the coherence controller includes an actuator which inserts an aperture stop into an optical path of the measurement light and the reference light, and retracts the aperture stop from the optical path.

4. The apparatus according to claim 1, wherein
the coherence controller includes a first aperture stop and a second aperture stop, the first aperture stop including an aperture having a dimension larger than a dimension of an aperture of the second aperture stop, and
the first aperture stop is fixed in an optical path of the measurement light and the reference light, and the second aperture stop is inserted into and retracted from the optical path in accordance with a measurement mode of coherence.

5. The apparatus according to claim 4, wherein the coherence controller includes an actuator which drives the second aperture stop.

6. The apparatus according to claim 1, wherein the physical information is one of a surface shape and a surface position of the object.

7. The apparatus according to claim 1, wherein the physical information is one of a thickness distribution and a thickness of a film formed on a surface of the object.

8. The apparatus according to claim 1, wherein the second aperture stop is inserted into the optical path on the measurement mode of first coherence and the second aperture stop is retracted from the optical path on the measurement mode of second coherence lower than the first coherence.

9. An exposure apparatus which projects a pattern of an original onto a substrate via a projection optical system to expose the substrate, the apparatus comprising:
a measurement apparatus which is arranged to measure a surface position of the substrate; and
a controller which controls a position of the substrate based on the result of measurement by the measurement apparatus, so as to reduce an amount of shift of the surface position from an image plane of the projection optical system,
the measurement apparatus including:
a beam splitter that splits light from a light source into measurement light to be directed to the substrate and reference light to be directed to a reference surface, and a beam combiner that combines the measurement light reflected by the substrate and the reference light reflected by the reference surface to generate combined light, wherein physical information of the substrate is obtained based on the combined light; and
a coherence controller which changes spatial coherences of the measurement light and the reference light.

10. A method of manufacturing a device, the method comprising the steps of:
exposing a substrate using an exposure apparatus; and
developing the exposed substrate,
wherein the exposure apparatus is configured to project a pattern of an original onto the substrate via a projection optical system to expose the substrate, and comprises:
a measurement apparatus arranged to measure a surface position of the substrate; and
a controller which controls a position of the substrate based on the result of measurement by the measurement apparatus, so as to reduce an amount of shift of the surface position from an image plane of the projection optical system,
wherein the measurement apparatus includes:
a beam splitter that splits light from a light source into measurement light to be directed to the substrate and reference light to be directed to a reference surface, and a beam combiner that combines the measurement light reflected by the substrate and the reference light reflected by the reference surface to generate combined light, wherein physical information of the substrate is obtained based on the combined light; and
a coherence controller which changes spatial coherences of the measurement light and the reference light.
